(19) United States
(12) Patent Application Publication
(10) Pub. No.: US 2005/0187804 A1
(43) Pub. Date: Aug. 25, 2005

(54) Evaluating employee benefit plans

(76) Inventors: Carolyn Clancy, Chelmsford, MA (US); Joseph Freitas, Hingham, MA (US); Mary Cusick, Brookline, MA (US); Christopher Burt, West Jordan, UT (US); Janet Roberts, Waltham, MA (US)

Correspondence Address: TESTA, HURWITZ & THIBEAULT, LLP, HIGH STREET TOWER, 125 HIGH STREET, BOSTON, MA, 02110, US

(21) Appl. No.: 10/782,195

(22) Filed: Feb. 19, 2004

(51) Int. Cl. G06F 17/60

(52) U.S. Cl. 705/8

(57) ABSTRACT

This invention relates to computerized methods and systems for evaluating employee benefit plans. In one embodiment, a computerized method for determining improvement actions for an employee benefit plan includes uniquely associating an improvement action for one or more attributes of an employee benefit plan; receiving the status of one or more of the attributes for a first employee benefit plan; identifying the attributes of the first employee benefit plan which have a different status than a set of other employee benefit plans, and providing an action plan to improve the first employee benefit plan, the action plan comprising one or more actions associated with the identified attributes.

### TECHNICAL FIELD

This invention relates to computer-based methods and systems for evaluating employee benefit plans and, more particularly, to computerized methods and systems for providing recommendations for improvements to employee benefit plans.

### BACKGROUND INFORMATION

Individuals currently depend on numerous sources of post-retirement income in order to maintain a high quality of life. In the past, typical American workers often relied on an employer funded retirement plan (such as a pension plan) and Social Security as the primary sources of retirement income. However, many companies no longer offer pension plans to their employees, and even those that do may not have the capabilities to perform the record keeping functions for the plans in a sufficient manner. Furthermore, most individuals recognize that Social Security is not sufficient as a primary source of post-retirement income, and many even doubt its long-term financial viability. To supplement these two sources of income, many employees participate in so-called “defined contribution plans”—commonly referred to as 401(k) or 403(b) plans—which are offered to the employees by their employer (the plan “sponsor”) as part of an employee benefit package. Further, because of the detailed and intricate statutory requirements of these plans, many plan sponsors outsource the record keeping functions to a financial services company or data processing company (the plan “record keeper”).

Many of these plans allow employees to designate some amount (often a pre-tax percentage or dollar amount) of their salary to one or more investment vehicles such as stocks, bonds, mutual funds, money market accounts, as well as others. One significant benefit of these plans is that under the current tax code, they provide tax-free or tax-deferred growth of capital. After contributing to such a plan over the span of an entire career, an employee can compile a significant retirement “nest-egg” to maintain their pre-retirement standard of living.

Although the basic structure and administrative requirements of these plans are statutory in nature, a plan record keeper may provide optional additional features to the plan sponsors. For example, a plan record keeper may offer a larger pool of investment options to certain plan sponsors, and likewise may provide varying levels and methods of customer support to the plan participants. This degree of flexibility allows plan sponsors to tailor a plan to the needs of the participants, meet the regulatory requirements of the IRS, SEC, and other agencies, while allowing the plan sponsors to control the cost of the plan. However, translating the many possible alternatives into discrete decisions about the design of the plan can be difficult. Tools which can assist plan sponsors in determining optimal plan design provide significant benefit to those plan sponsors.

### SUMMARY OF THE INVENTION

In general, the invention relates to computer-based methods and tools that allow a sponsor or record keeper of an employee benefit plan to compare feature sets associated with one employee benefit plan with feature sets of other employee benefit plans. Attributes of the feature sets are compared to plan data from plan sponsors with similar characteristics to those of the plan sponsor, and thus provide a more accurate comparison and improvement suggestions that are more relevant for that particular sponsor.

Such tools allow sponsors, who are often the employers of the plan participants, to select and review certain attributes of the plan(s) they offer to their employees. By providing the status of these attributes (e.g., offered, not offered, etc.), a plan sponsor receives an overall “score” for their plan. Thus, the sponsor can determine if they should consider adding optional features to their plan, and review suggested action items that may have a positive effect on a plan metric such as participant engagement, diversification, etc. In addition, the plan record keeper may also use the results to suggest changes to the plan to increase revenue generated by the plan, decrease costs of the record keeping functions of the plan, as well as other metrics.

Such methods and tools can compare numerous attributes of an employee benefit plan (e.g., number of investment options available, the usage of web-based customer service, the average account balances, etc.) to those of other plans without compromising the confidentiality of the data. Further, such a system allows a record keeper to associate suggested action items with particular attributes, and, where a plan falls short of a particular benchmark, recommend actions to increase plan participation, diversification, and other plan metrics.

While particularly useful for defined contribution plans, these methods and tools are not limited to that specific application, and can be used to design and evaluate similar plans such as pension plans, medical plans, as well as other benefit plans offered to employees.

In one aspect, the invention relates to a computerized method for assessing the features of an employee benefit plan. The method comprises providing attributes of a first employee benefit plan and the attributes of a set of other employee benefit plans, each of the plans having a plan sponsor and a plan record keeper and determining a subset of other employee benefit plans to which the attributes of the first employee plan are compared.

An employee benefit plan can be, for example, a defined benefit plan such as a pension plan, a defined contribution plan such as a 401(k) or 403(b) plan, a deferred compensation plan such as a 457 plan, an employee stock purchase plan, or a healthcare plan. In some embodiments, the plan record keeper provides the attributes of the first plan to the sponsor of the plan. In some embodiments, the plan record keeper provides the attributes of the other plans to the sponsor of the plan. In some embodiments, the plan sponsor provides the attributes of the first plan to the record keeper of the plan. The record keeping functions for the first employee plan and for the other employee plans can be performed by the same entity, or in some embodiments, by two or more entities.

In some embodiments, characteristics of the sponsors of the other plans are used to determine the plans to be included in the comparison subset. These characteristics may include one or more of the number of employees of the sponsor, the industry in which the sponsor operates, the non-profit status of the sponsor, and the geographic region of the sponsor. In some embodiments, the first plan is in the subset of plans to which it is being compared.

In some embodiments, the first plan can be compared to the subset of the other plans using one or more metrics such as plan participation, plan diversification, participant contribution levels, participant account balances, and participant interaction. Further, the metrics may be divided into one or more sub-metrics such as the age of the plan participants, the options available for plan diversification, and the customer service channels used by the plan participants. In some embodiments, the comparison step includes comparing sub-sub-metrics of the first plan and the subset of the other plans.

In another aspect, the invention relates to computerized methods for providing an action plan to improve an employee benefit plan. The method comprises uniquely associating an improvement action for attributes of an employee benefit plan and providing the status of one or more of the attributes of a first employee benefit plan. Further, the method includes providing an action plan to improve the first employee benefit plan, the action plan comprising one or more of the actions associated with the identified attributes. In some embodiments, the method further includes displaying the action plan on a printed report, and in some embodiments, on a web page.

In one embodiment, the method includes selecting the employee benefit plans that are included in the set of other employee benefit plans based at least in part on the characteristics of the sponsors of the other employee benefit plans. In some embodiments, the statuses for the attributes of the plans are requested via an online questionnaire. In some embodiments, the statuses are requested from the record keeper of the first plan, and in some embodiments the statuses are requested from the sponsor of the first plan.

In another embodiment, the method includes associating the attributes of the first plan with one or more metrics. In one exemplary embodiment, the metrics are one or more of: plan participation, plan diversification, participant contribution levels, participant account balances, and customer interaction. In some embodiments, the method includes performing the identification step using one or more of the metrics.

Another aspect of the invention provides a computer-based system for assessing the quality of an employee benefit system, including means for storing attributes of employee benefit plans, means for segmenting the employee benefit plans into groups based on the characteristics of the plan sponsors, means for deriving a benchmark metric for each group of plans, means for transmitting attributes of an employee benefit plan to a user, means for receiving an indication of the status of the attributes of the plan, and means for comparing the received status with the benchmark metric.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a block diagram of an embodiment of the invention.

FIG. 2 is a block diagram of an embodiment of a system according to the invention.

FIG. 3 is a block diagram of an embodiment of a server in the system of FIG. 2.

FIG. 4 is a flowchart of an embodiment of a method according to the invention.

FIG. 5 is a continuation of the flowchart of FIG. 4.

FIG. 6 is a flowchart of an embodiment of a method according to the invention.

FIG. 7 is a screen display of a screen of an embodiment of the invention.

FIG. 8 is a screen display of a segmented benchmark screen in an embodiment of the invention.

FIG. 9 is a screen display of a sub-segmented benchmark screen in an embodiment of the invention.

FIG. 10 is a screen display of a diagnostic screen in an embodiment of the invention.

FIG. 11 is a screen display of a results screen in an embodiment of the invention.

FIG. 12 is a screen display of an opportunities screen in an embodiment of the invention.

FIG. 13 is a screen display of a summary screen in an embodiment of the invention.

FIG. 14 is a screen display of a custom report builder screen in an embodiment of the invention.

### DETAILED DESCRIPTION

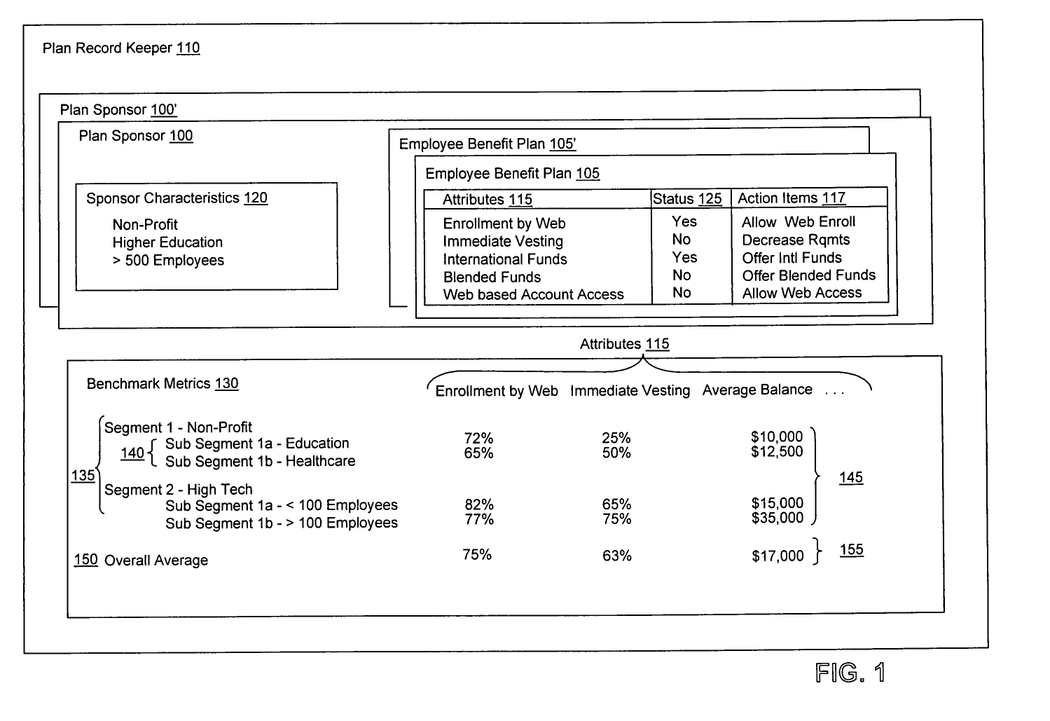

Referring to FIG. 1, in one embodiment, a plan sponsor (“sponsor”) 100 provides one or more employee benefit plans (“plans”) 105, 105′, generally 105 to its employees. Because of the significant overhead and regulatory requirements involved in the development and record keeping for the plans 105, many plan sponsors 100, 100′ contract with a plan record keeper (“record keeper”) 110 to provide these services. Examples of plan record keepers include financial services companies such as banks, brokerage houses, insurance companies, and individual financial advisors, as well as data processing companies. In some cases, the record keeper 110 may act as a plan administrator as defined by ERISA and have fiduciary responsibilities toward the plan sponsor, and in some cases may have no such relationship with the sponsor 100 and provide only data processing and record keeping services. In some cases, the record keeper 110 offers various types of plans 105 to sponsors 100. The number, types, and attributes 115 of plan 105 may depend, for example, on certain characteristics 120 of the sponsor 100.

For example, a record keeper 110 may offer various plans 105 with numerous optional attributes 115 to a sponsor 100 such as large public corporation with thousands of employees. The plans 105 may include a defined benefit plan such as a 401(k) or 403(b) plan, a deferred benefit plan such as a pension plan, a deferred compensation plan such as a 457 plan, and a health and welfare plan such as medical or dental insurance plans. Attributes 115 may include services offered with the benefit plans, design features of the plans, or in some embodiments, both. Further, the optional attributes 115 may include a web-based enrollment and customer service, a dedicated support staff, a large number of investment options, availability of loans, vesting periods, and the like. In another example, the same record keeper 110 may offer only one plan 105 (e.g., a 403(b) or similar plan) to a sponsor 100 such as a small non-profit organization. In cases where such small, non-profit sponsors 100 cannot afford multiple large plans 105 with a wide variety of optional attributes 1115, the sponsors 100 often elect not to include these attributes 115 in the plan or plans 105 offered to their employees. Proper record keeping of the plans 105 100 requires that the record keeper 110 maintain the status 125 of each attribute 115.

In one embodiment, the plan record keeper 110 associates one or more action items 117 with the attributes 115 of the plan 105. These action items 117 can include offering informational sessions about the benefits of participating in the plan 105, offering additional investment vehicles for the employees, changing the vesting requirements, increasing the availability or type of customer service support channels available to the employees, as well as others. In one particular embodiment, the record keeper 110 associates the action items 117 with the attributes by reviewing the status 125 of numerous attributes 115 of many plans 105 offered by a wide variety of sponsors 100. By suggesting action items 117 for specific attributes 115 of the plan 105 the sponsor 100 can be presented with action items 117 that are not offered in the current plan, and that may increase a particular metric of interest (e.g., plan participation) to the sponsor.

In an attempt to provide additional value to the sponsors 100, some record keepers 110 offer benchmark metrics 130 to the sponsors 100. Because one record keeper 110 may manage multiple plans 105 for many sponsors 100, the record keeper 110 can compile the metrics 130 from the attributes 115 of many, often hundreds or thousands of plans 105. Furthermore, industry-wide metrics are often available from sources such as government agencies and private data services. A plan sponsor 100 and/or a plan record keeper 110 can then use the metrics 130 to gauge the success of a particular plan 105 for a particular sponsor 100 relative to other companies. However, a sponsor 100 such as a small private university may not find much value in comparing the metrics of the plan 105 offered to its faculty to overall metrics 130 including large international corporations and other for-profit entities.

Therefore, in one embodiment of the invention, the record keeper 110 creates segments 135 of the overall population of sponsors 100 based, at least in part, on certain sponsor characteristics 120. For example, and still referencing FIG. 1, the record keeper 110 can define two segments 135, non-profit and high technology. In some embodiments, the record keeper 110 can define additional segments 135 based on characteristics 120 such as company size, geographic location, industry, or others. In some embodiments, the record keeper 110 may define sub-segments 140 by combining one or more characteristics 120.

One potential set of sub-segments 140 where the metric values 145 for a particular attribute 115 may differ significantly may be non-profit/education and large high technology companies. For example, a sponsor 100 such as a non-profit educational institution may be concerned that its employees were not contributing adequate funds to their accounts. In this case, the metric values 145 may indicate that in fact, the average account balance for participants across all segments 135 is significantly higher than the sponsor's average account balance metric value. However, by sub-segmenting the data, the sponsor 100 may in fact have a higher average account balance than the majority of other similar plan sponsors. This is because the higher average account balance metric value may include for-profit and other larger entities that can afford to offer more elaborate plans 105 to its employees, whereas the lower average account balance metric value may include only those sponsors 100 that are members of the non-profit educational sub-segment. After reviewing the data in this fashion, the non-profit educational sponsor 100 may decide not to add additional, potentially costly attributes 115 to their plan 105, thus saving money. In some embodiments, the record keeper 100 may calculate overall metric values 155 for the overall population of plans 150 and provide the values in addition to the sub-segment attribute metric values 145.

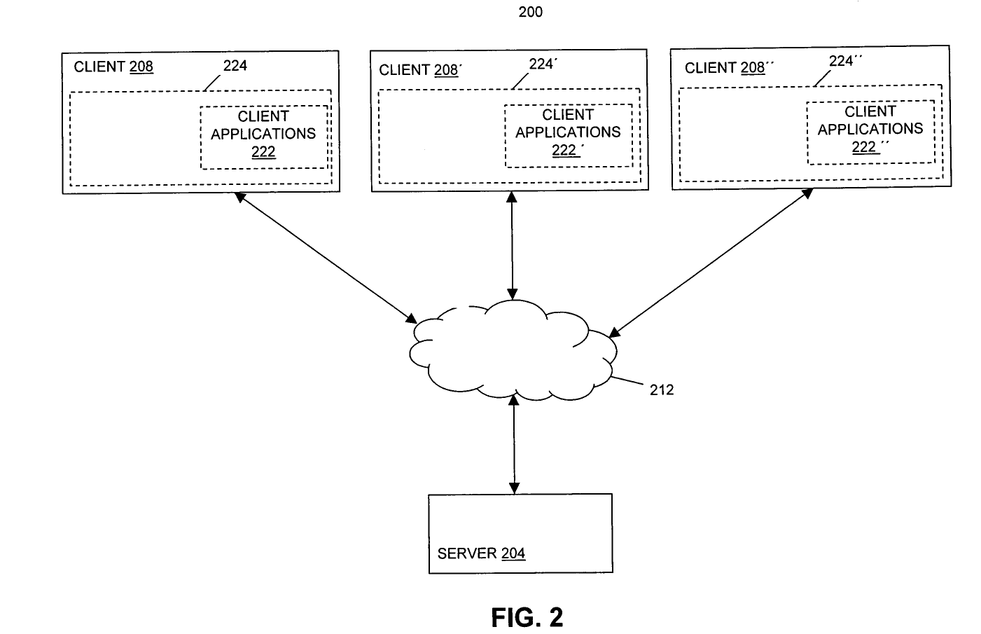

Referring to FIG. 2, in one embodiment, the methods described above may be implemented using an employee benefit assessment system 200 including at least one server 204, and at least one client 208, 208′, and 208″, generally 208. As shown, the system 200 includes three clients 208, 208′, 208″, but this is only for exemplary purposes, and it is intended that there can be any number of clients 208. The client 208 is preferably implemented as software running on a personal computer (e.g., a PC with an INTEL processor or an APPLE MACINTOSH) capable of running such operating systems as the MICROSOFT WINDOWS family of operating systems from Microsoft Corporation of Redmond, Wash., the MACINTOSH operating system from Apple Computer of Cupertino, Calif., and various varieties of Unix, such as SUN SOLARIS from SUN MICROSYSTEMS, and GNU/Linux from RED HAT, INC. of Durham, N.C. (and others). The client 208 could also be implemented on such hardware as a smart or dumb terminal, network computer, personal data assistant, wireless device, information appliance, workstation, minicomputer, mainframe computer, kiosk, or other computing device, that is operated as a general purpose computer or a special purpose hardware device solely used for serving as a client 208 in the employee benefit plan assessment system 200.

Generally, the sponsors 100 or record keepers 110 of one or more plans 105 operate the clients 208. In various embodiments, the client computer 208 includes client applications 222. One example of a client application 222 is a web browser application that allows the client 208 to request a web page (e.g. from the server 204) with a web page request. An example of a web page is a data file that includes computer executable or interpretable information, graphics, sound, text, and/or video, that can be displayed, executed, played, processed, streamed, and/or stored and that can contain links, or pointers, to other web pages. In one embodiment, a user of the client 208 manually requests a web page from the server 204. Alternatively, the client 208 automatically makes requests with the web browser. Examples of commercially available web browser software are INTERNET EXPLORER, offered by Microsoft Corporation of Redmond, Wash., and NETSCAPE NAVIGATOR, offered by AOL/Time Warner of Mountain View, Calif.

A communications network 212 connects the client 208 with the server 204. The communication may take place via any media such as standard telephone lines, LAN or WAN links (e.g., T1, T3, 56 kb, X.25), broadband connections (ISDN, Frame Relay, ATM), wireless links, and so on. Preferably, the network 212 can carry TCP/IP protocol communications, and HTTP/HTTPS requests made by the web browser and the connection between the client applications 222 and the server 204 can be communicated over such TCP/IP networks. The type of network is not a limitation, however, and any suitable network may be used. Typical examples of networks that can serve as the communications network 212 include a wireless or wired ethernet-based intranet, a local or wide-area network (LAN or WAN), and/or the global communications network known as the Internet, which may accommodate many different communications media and protocols.

In some embodiments, an employee of the record keeper 110 operates a central server 204, which interacts with clients 208. In some embodiments, a third party may manage the server 204, which may include providing the hardware, communications, and service to the server 204. The server 204 is preferably implemented on one or more server class computers that have sufficient memory, data storage, and processing power and that run a server class operating system (e.g. SUN Solaris, GNU/Linux, MICROSOFT WINDOWS 2000, or other such operating system). Other types of system hardware and software than that described here could also be used, depending on the capacity of the device and the number of users and the amount of data received. For example, the server 204 may be part of a server farm or server network, which is a logical group of one or more servers. As another example, there could be multiple servers 204 that may be associated or connected with each other, or multiple servers could operate independently, but with shared data. As is typical in large-scale systems, application software could be implemented in components, with different components running on different server computers, on the same server, or some combination.

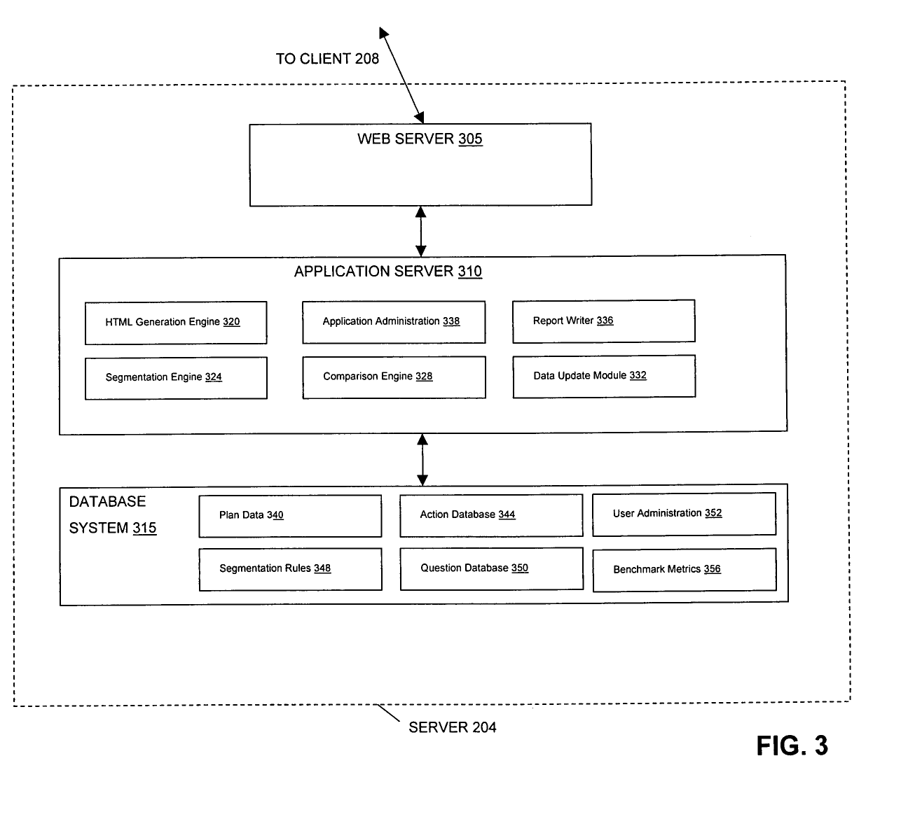

Referring to FIG. 3, in one embodiment, a server 204 includes a web server module 305 that is the interface for communication with clients 208 involving the transfer of files and data. In some embodiments, the web server module 305 is the interface for communication with clients 208 involving HTTP/S requests and responses, Java messages, SMTP messages, POP3 messages, instant messages, as well as other electronic messages. In some instances, messages may be transferred from the client 208 to the server 204, from the server 204 to the client 208, or both. The web server module 305 can be implemented as software running on one or more servers, or may be implemented as a stand-alone server. In some embodiments, the web server module 305 can provide an interface to client applications 222, so that, for example, a user can send and receive e-mail, instant messages, and so on.

The web server module 305 communicates with an application server 310, which provides the main programming logic for the operation of the system 200. In one embodiment, the application server 310 is implemented as one or more application programs (e.g., Internet Information Server from Microsoft Corporation, WebSphere from International Business Machines Corporation, or other such application) running on a server class computer, which may be the same or different computer as the web server module 305. The application server 310 receives requests for employee benefit plan data (such as participation rates, account balances, the current status 125 of one or more attributes 115, etc.) from users via a client 208 and the web server module 305. The application server 310 may also receive requests for data stored in a database (such as participation rates, account balances, participant statistics, etc.) from users via a client 208 and the web server module 305.

The application server 310 includes an HTML generation engine 320, a segmentation engine 324, a comparison engine 328, a report writer 336, an application administration module 338 for managing application procedures and logic, and a data update module 332 for providing updates to the administration module 338 and database system 315. The HTML generation engine 320 reads static HTML stored in files on the application server 310 and requests data from the database system 315 to produce completed HTML pages, which in turn are sent to the client 208 via the web server 305. The HTML pages may, in some cases, include data or text directed to a specific user, regarding a specific plan 105, or other context dependent data. In some embodiments, the compilation of HTML code uses the Active Server Page (“ASP”) technology from Microsoft Corporation of Redmond, Wash. to combine static HTML and data or context specific data into one or more HTML pages prior to being sent to the client 208. In some embodiments, JAVA, JavaScript, XML, or other like programming languages can be used to generate HTML code or present data, text and/or graphics to a user. In one exemplary embodiment, the HTML pages include forms, which are presented to a user on the client 208. The forms allow the user to input data, select from a series of options, and provide other responses to questions presented on the page. In one exemplary embodiment, the data refers to the attributes 115 of an employee benefit plan 105 and the status 125 of one or more attributes 115 of the plan 105. Upon completing a form, the user sends the completed form via an HTML post command to the web server 305, which in turn provides data to the application server 310 and the database system 315.

The segmentation engine 324 receives data relating to employee benefit plans 105, the sponsors 100 of the plans 105, the participants of the plans, as well as other data, from the database system 315 and groups the plans into segments 135. In one embodiment, the segmentation engine 324 groups the plans 105 based on characteristics 120 of the sponsors 100 such as industry (high tech, retail, non-profit, etc.), sub-industry (i.e. non-profit can be further segmented in to healthcare, education, charitable organizations, etc.), geography, number of employees, or others. By grouping the plan data into segments 135 based on the sponsor characteristics 120, the segmentation engine 324 can calculate benchmark metrics 130 for each segment 135 or sub-segment 140. The segmentation engine 324 can send the benchmark metrics 130 to the database system 315 for storage, or, in some embodiments, can calculate the metrics 130 in real-time and provide the metrics to the comparison engine 328 on an as needed basis. In some embodiments, an external system provides the metrics 130 to the application server 310 and/or the database system 315 via data feeds, uploads, file transfers, or other similar means.

The comparison engine 328 receives the status 125 of one or more plan attributes 115 from a users of the system 200 and compares the statuses to the attribute metrics 145 for similar attributes 115 from plans 105 in a like segment 135, sub-segment 140, and in some embodiments, and overall metric 150. In some embodiments, the comparison is binary—i.e. a status 125 of “yes” for an attribute 115 is compared to the percentage of sponsors 100 in a particular segment 135 or sub-segment 140 that have a similar status 125. In still other embodiments, the comparison engine 328 further segments the metrics 130 by demographics (e.g., age of participant), average account balances, and the like. By further segmenting the metrics 130, the sponsor 100 can determine if there is a particular population of their employees whose requirements are not being fully addressed by the current attributes 115 of the plan 105. For example, a hospital may offer a particular plan 105 to its employees, and the status 125 of the attributes 115 of the plan 105 may be favorable to similar sponsors 100—i.e. they may offer a wider range of services and options than other hospitals. However, one population of the employees, such as those under 30, may have lower participation rates and account balances than other hospitals. To address this discrepancy, the hospital could then implement action items aimed at increasing the participation of its younger workers. Because the plan record keeper 110 provides the metrics 130 for a particular segment, the sponsor 100 can see action items targeted at their particular issues.

The application server 310 also includes a report writer 336. The report writer 336 compiles data, text, graphics and other information from the database system or other applications 315 and other components of the application server 310 and produces reports for the user of the system 200. The report may include plan attributes 115, the status 125 of the attributes 115, action items 117 to improve on a particular metric, overall benchmark metrics 150, segmented attribute metrics 145, as well as other information about the plan 105 and the sponsor 100. In one embodiment, the report can generated in HTML, sent from the server 204 to the client 208 over the communications network 212, and viewed on a client application 222, printed, or saved locally to the client 208.

Continuing to refer to FIG. 3, the server 204 also includes a database system 315, for storing data related to the employee benefit plans 105, the plan sponsors 100, user permissions, segmentation parameters, improvement actions 117, and the like in one or more databases. For instance, the database server 315 may store information relating to employee benefit plans, attributes of the plans, stored content, user information, server availability, and web traffic information. The database server 315 may also contain separate databases for plan data 340, improvement actions 344, segmentation rules 348, user questions 350, user administration 352, benchmark metrics 356, and others. The database server 315 also provides data to the application server 310 upon request, and updates data as necessary. An example of the database server 315 is the MySQL Database Server by MySQL AB of Uppsala, Sweden, the SQLServer database system of Microsoft Corporation of Redmond Wash., or the ORACLE Database Server offered by ORACLE Corp. of Redwood Shores, Calif.

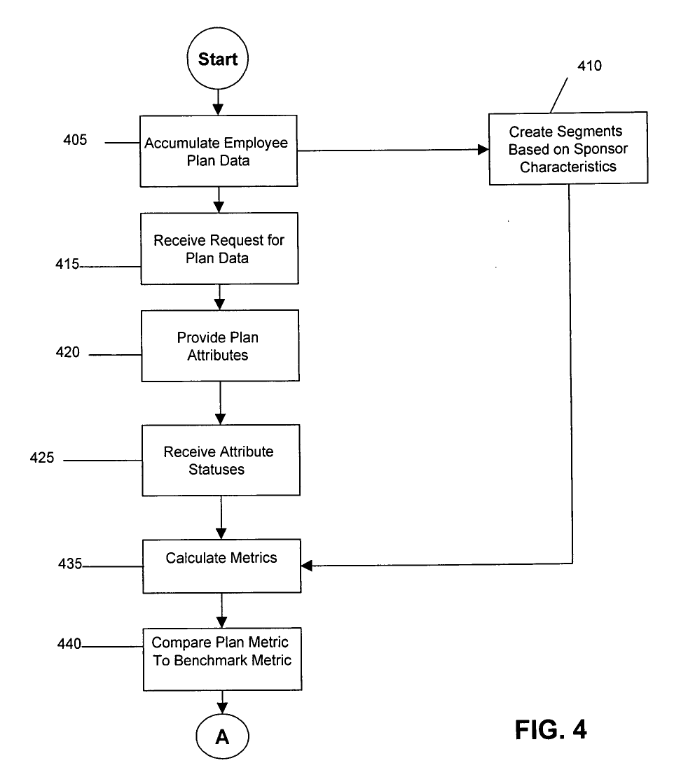

FIG. 4 illustrates one embodiment of a method for comparing metrics derived from the attributes of an employee benefit plan to benchmark metrics derived from benefit plans offered by sponsors with similar characteristics and providing the results of the comparison. Initially, a plan record keeper 110 accumulates data relating to one or more employee benefit plans 105 and the sponsors 100 of the plans (STEP 405). The segmentation engine 324 then creates segments 135 of the data based on characteristics 120 of the sponsors 100 (STEP 410). Subsequently, the system 200 receives a request from a user for data about a plan 105 (STEP 415) and provides attributes 115 of the plan 105 to the user (STEP 420). The user may be a representative of the sponsor 100 of the plan 105, or the record keeper 110 of the plan 105. The user then reviews the information provided, completes any forms or questionnaires regarding the status 125 of the attributes 115 of the plan 105, and transmits the data back to the system 200 (STEP 425) via the web server 305 and network 112. The comparison engine 328 then calculates one or more metrics for the plan 105 and calculates aggregated benchmark metrics 130 for each segment of plans 135 (STEP 435). The comparison engine 328 then compares the plan metrics to the attribute metrics 145 for its segment 135, sub-segment 140, and/or the overall benchmark metrics 150 (STEP 440).

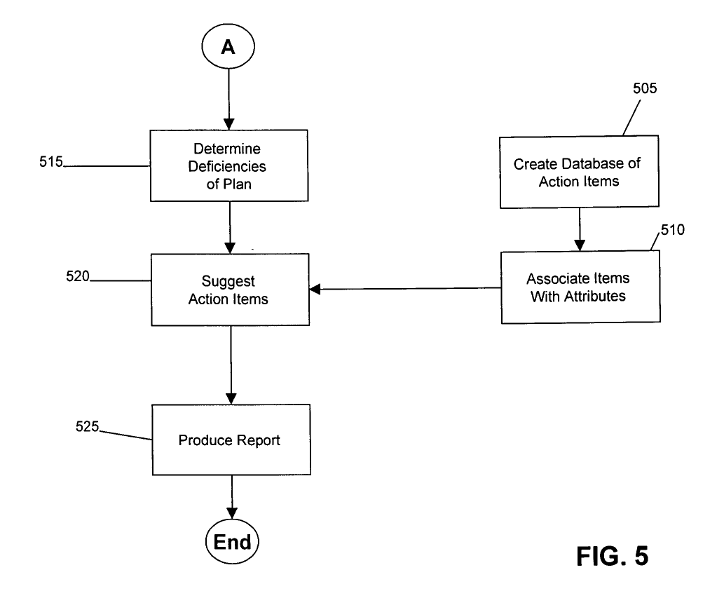

Because sponsors 100 of a particular plan 105 see the metric for their plan compared to benchmark metrics 130 for plans from sponsors with similar characteristics 120, the sponsor 100 can make a better decision whether to offer additional optional features of a plan to their employees. For example, a university may provide a 403(b) plan to its employees, but not offer immediate vesting in the plan. If the university knew that on average, the account balances and participation rates for their plan were significantly below industry averages for those metrics, they might be tempted to change their policy plan design. While such a change would be beneficial to the employees, it may add additional costs to the funding of the plan for the university. However, if the representative knew that the participation rate and account balances metrics for their plans, while below the overall industry metrics, were in fact above the same metric for their sub-segment 140, the university could justify not offering such a benefit to its employees. By providing this level of segmentation, the plan record keeper 110 adds significant value to the services they provide to the plan sponsors. Referring to FIG. 5, the plan record keeper 110 creates a database of action items 117 (STEP 505) and associates the action items 117 with attributes 115 relating to a plan 105 (STEP 510). Subsequent to the comparison step described above, the comparison engine 338 determines one or more deficiencies of the plan 105 by comparing one or more metrics of the plan 105 to the segmented attribute metrics 145 (STEP 515). Where discrepancies occur, the comparison engine 328 identifies the attributes 115 that are associated with the metric, the actions items 117 that are associated with those attributes 115, and suggests one or more identified action items 117 (STEP 520). The report writer then produces a report detailing various benchmark metrics 130, segmented attribute metrics 145, plan attributes 115, attribute statuses 125, strengths of the plan, and possible action items 117 for improving the plan (STEP 525). In some embodiments, the plan sponsor 100 or plan record keeper 110 can select which metrics and action items to include on the report. A plan record keeper 110, a plan sponsor 100, or other user of the system 200 can use the report as support for implementing potential changes in attributes to a particular plan, or to provide information about the strength of the plan relative to peers of the sponsor 105.

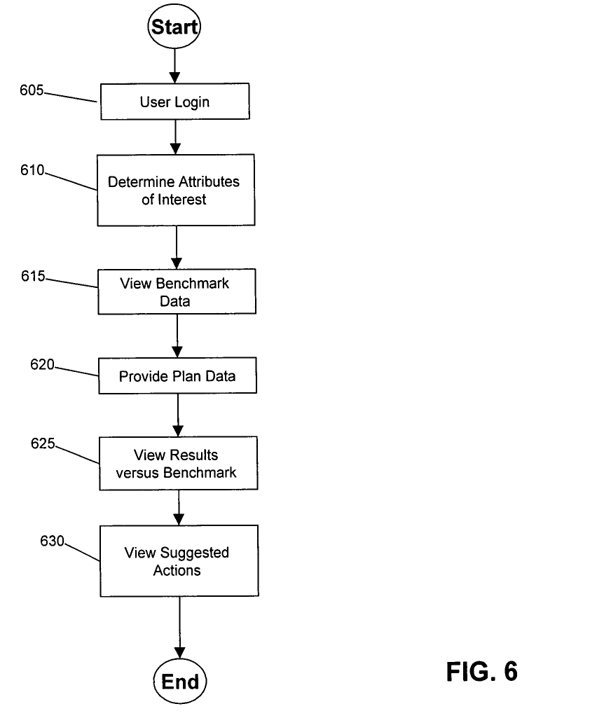

FIG. 6 illustrates one embodiment of a method for receiving recommendations for improving an employee benefit plan. Initially, a user logs into the system 200 by providing a user ID, password, PIN number, biometric data, or other authentication data (STEP 605). The user then decides which plan metrics the user is interested in improving (STEP 610). The user may then view overall benchmark metrics 130 and segmented attribute metrics 145 for the attributes (STEP 615), and provides additional data about the plan 105 such as the status 117 of one or more attributes 115 (STEP 620). The user then views the results of the comparison to the benchmarks (STEP 625) and is presented with action items 117 that are designed to address any shortfalls with respect to the benchmarks (STEP 630) associated with the plan metrics. The action items 117 can be viewed on the client 208 using one or more client applications 222, printed out onto a paper report, stored in the database system 315, or otherwise communicated to the user. By presenting the user with a list of action items 117 for those attributes 115 that compare unfavorably to the comparison segment 145, the sponsor 100 110 can target their efforts and make changes to the plan 105 accordingly.

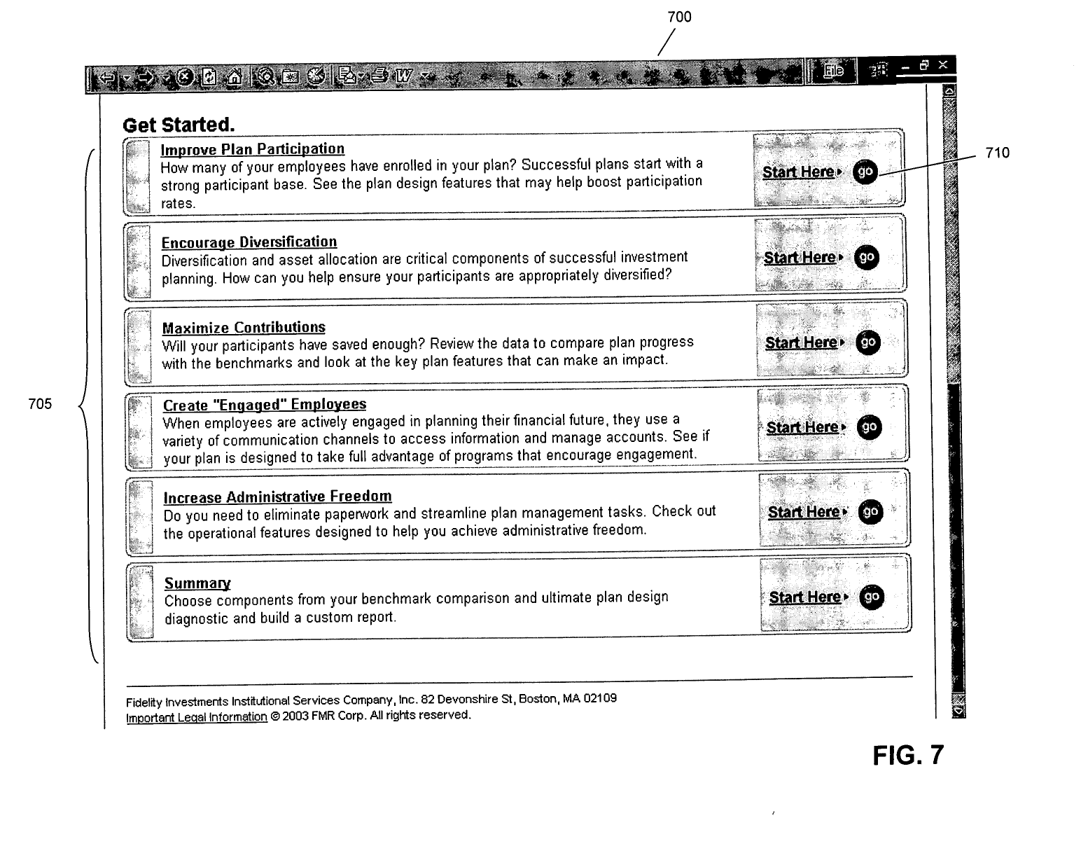

FIGS. 7 through 14 illustrate one embodiment of a system for implementing the methods described above. Referring to FIG. 7, in one exemplary embodiment, the application server 310 provides a Get Started screen 700 to the client 108 via the communications network 112. The Get Started screen 700 provides a starting point where the user can review one or more plan goals 705 and a description of the benefits to the plan participants and sponsor 100 of achieving these goals. Included on the screen 700 are buttons and links 710 allowing a user to continue with the process once the user determines which goal 705 they want to address.

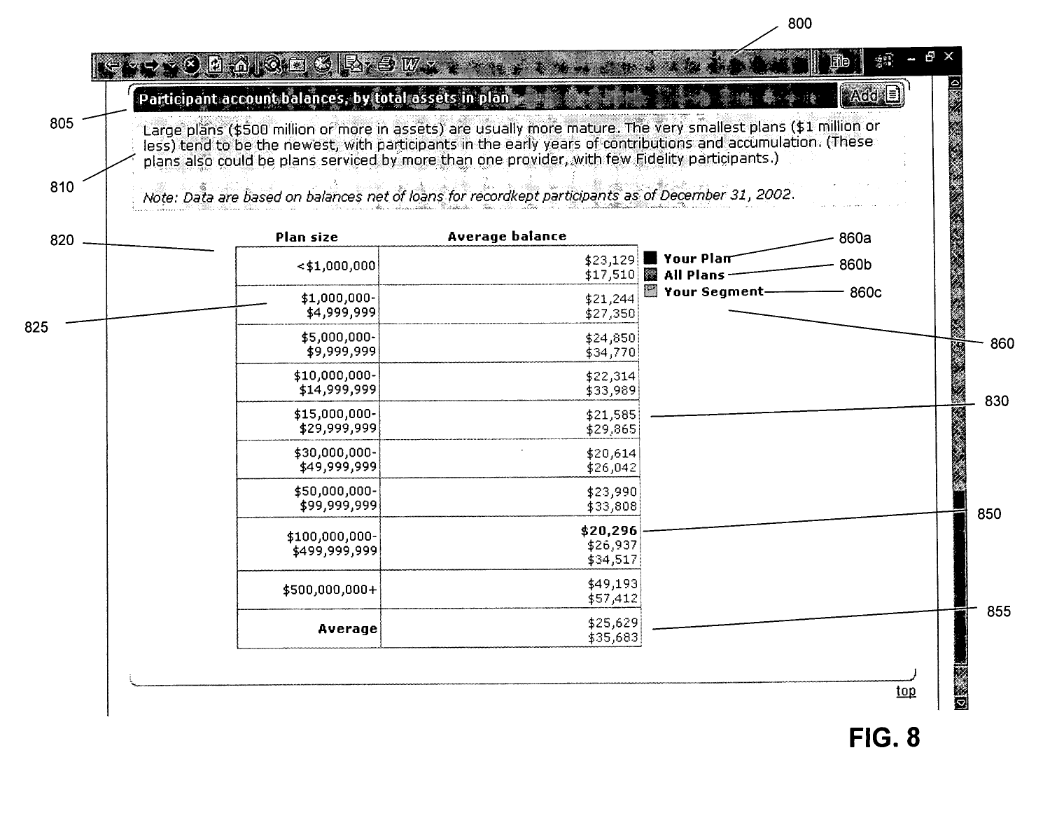

Referring to FIG. 8, once a user determines which goal 705 they want to address, the application server 310 provides a benchmark screen 800 to the client 108 via the communications network 112. The benchmark screen 800 provides one or more graphical depictions 820 of metrics relating to the selected plan goal and includes a metric title 805, and information about the segmentation of the metrics 810. In one embodiment, the graphical depiction 820 of metrics describes the average account balance of a retirement plan segmented by the overall size of the plan. The graph 820 includes segments 825 into which one or more plans are assigned, metrics values 830 for each segment, a metric value for the current plan 850, and an overall average metric value 855.

In one exemplary embodiment, the metric values 830 are shaded different colors and indicated in a legend 860. For example, in the graph 825 illustrated in FIG. 8, the legend 860 includes listings for the Your Plan 860a (the current plan), All Plans 860b, and Your Segment 860c. By distinguishing between those metrics that are overall benchmark metrics 855 and those that are assigned to the same segment as the current plan 850, the user has a better indication of how their plan rates compared to plans offered by similar sponsors.

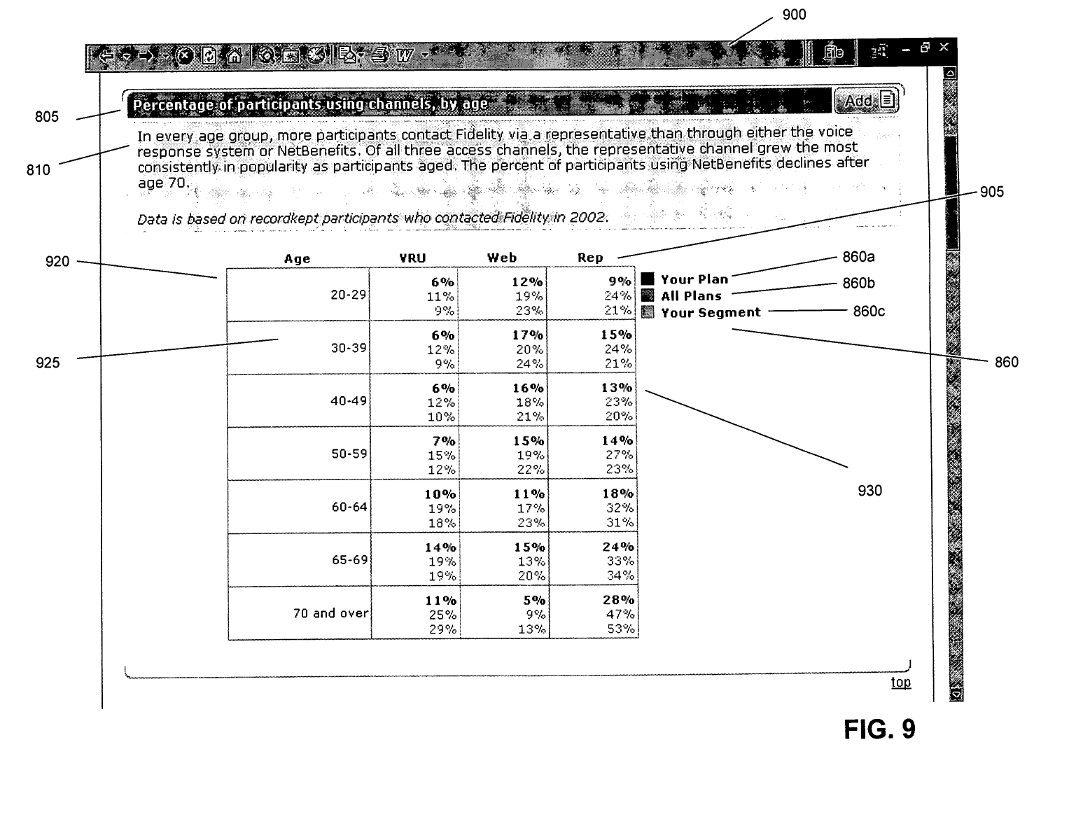

In some embodiments, the plan metrics are further segmented into sub-segments. For example, and referring to FIG. 9, the metric is segmented and sub-segmented. Similar to the prior benchmark screen 800, a sub-segment benchmark screen includes a metric title 805, a brief discussion of its importance 810 in achieving a plan goal, and a graphical representation 920 of the metric values 930. In addition to segmenting the metric values by a first segment 925 (in this case age), the metrics are sub-segmented 905—in this case customer service channel used. As described above, the metric values 930 are shaded different colors and indicated in a legend 860. For example, in the graph 925 illustrated in FIG. 9, the legend 860 includes listings for the Your Plan 860a (the current plan), All Plans 860b, and Your Segment 860c. In the example of FIG. 9, the data indicates the current plan, the percentage of customer service calls handled by the Web is lower for every age category than the benchmark metrics for that segment by an average of 7.85%. (11%, 7%, 5%, 7%, 12%, 5%, and 8%) This comparison is accentuated because the measurement is only 3.43% when comparing the current plan to the overall metric. Therefore, the plan sponsor may want to consider increasing the availability of services offered via the web to improve participant satisfaction and participation.

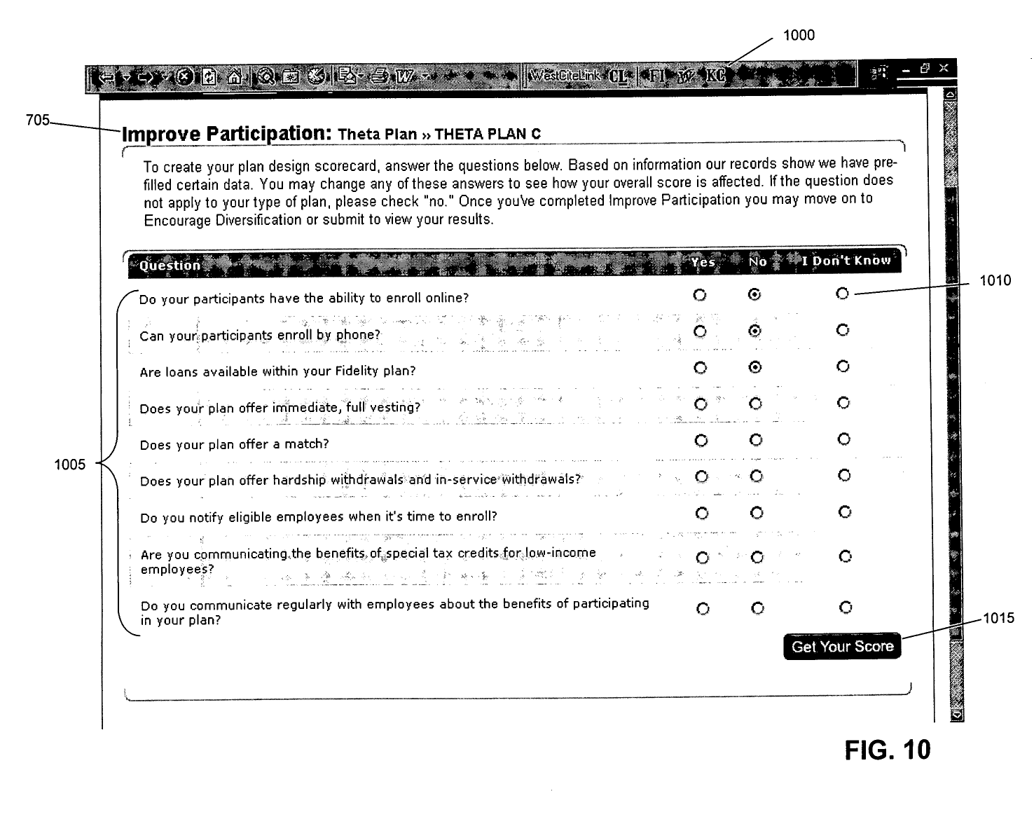

Referring to FIG. 10, once a user has reviewed the benchmarks (130 and 145) for one or more plan goals, the application server 310 provides a diagnostic screen 1000 to the client 208 via the communications network 212. The diagnostic screen 1000 provides an online questionnaire consisting of a list questions 1005 relating to the status 125 of one or more plan attributes 115, radio buttons 1010 indicating the status 125 of the attribute 115, and a Get Your Score button 1015 for submitting the completed form to the server 204. In some embodiments, the radio button 1010 is pre-filled with the current status 125 based on data provided to the application server 310 by the database system 315. In some embodiments, the radio button 1010 is left blank. The user completes the form by indicating the current status 125 of each attribute 115, and submits the form to the application server 310 to receive a metric for that plan goal. By allowing the user to change the status 125 of one or more attributes 115 and re-score the plan 105, they can see how adding or removing a particular attribute 115 from the plan 105 affects the plan goal 705.

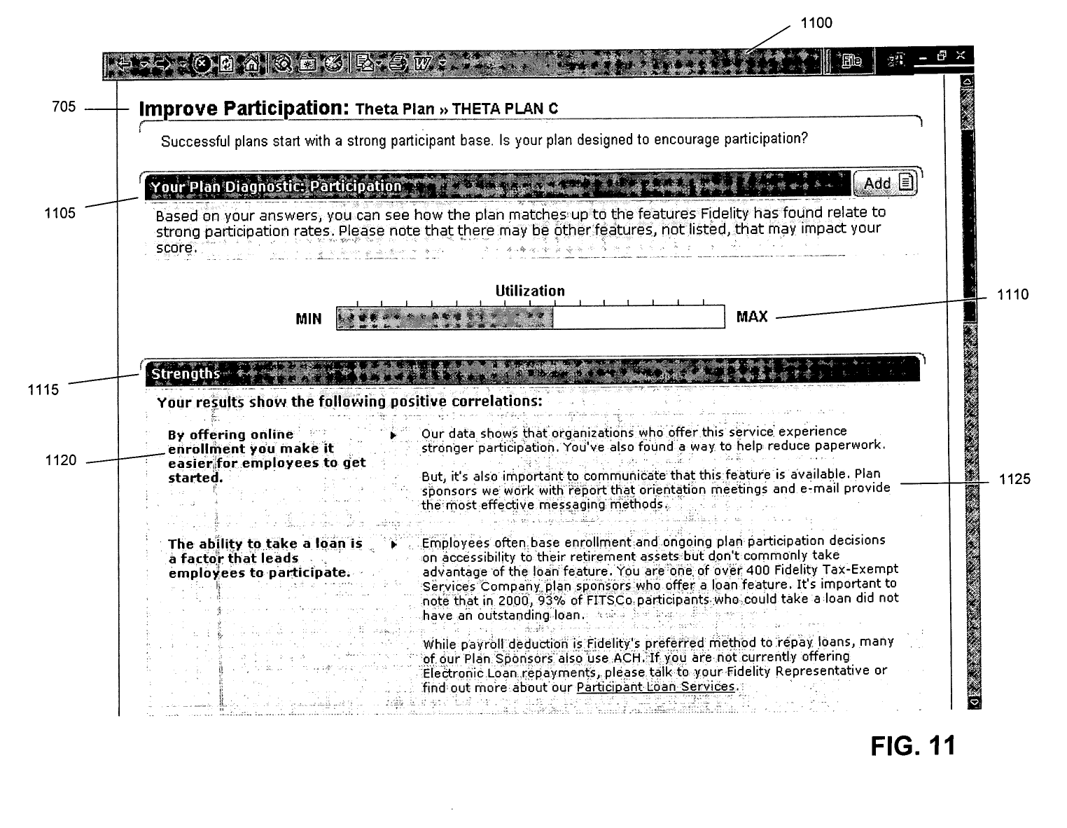

Referring to FIG. 11, once a user has requested a score for a plan metric, the application server 310 provides a results screen 1100 to the client 208 via the communications network 212. The results screen 1100 includes the plan goal 705, a description 1105 of the goal 705, a graphical representation 1110 of the score for the current plan for that goal 705 indicating how well the plan participants use the key plan features, a strengths section 1115 listing the attributes 115 of the plan that have a positive impact on its score, and text 1125 supporting the relationship between the attribute 115 and a positive score.

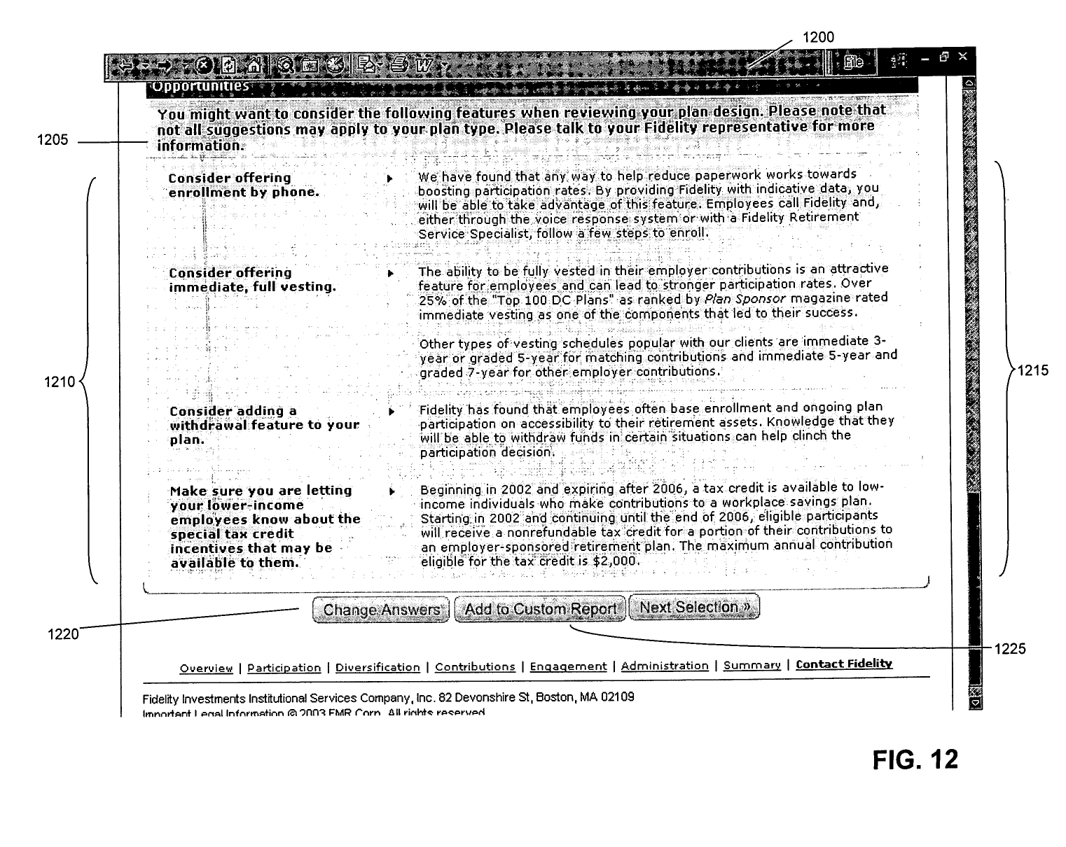

In addition to providing the positive results of the comparison, the system 200 provides the user with listing of action items 117 that are aimed at improving the plan score. Referring to FIG. 12, the application server 310 provides an opportunities screen 1200 to the client 208 via the communications network 212. The opportunities screen 1200 includes a listing of suggested action items 1210, supporting documentation 1215 for each action item 117, a button to redisplay the diagnostic screen 1000, and a button 1225 to add the suggested action items 117 to a custom report. In one embodiment, the list of action items 1210 consists of those action items 117 associated with the plan attributes 115 the user indicated were not offered in the current plan. For example, if a plan sponsor 100 wishes to increase the overall enrollment in the benefit plans they offer to their employees, the sponsor 100 may use the diagnostic screen 1000 for the “Plan Participation” metric and indicate the current status 1010 for each attribute listed on that screen 1005. If the sponsor 100 indicates that the current plan does not allow participants to enroll in the plan using the telephone, the list of action items 1210 on the opportunities screen 1200 could include the action of offering enrollment by phone. In addition, the supporting text provides a description of how the implementation of the action item may improve the plan metric in a given area.

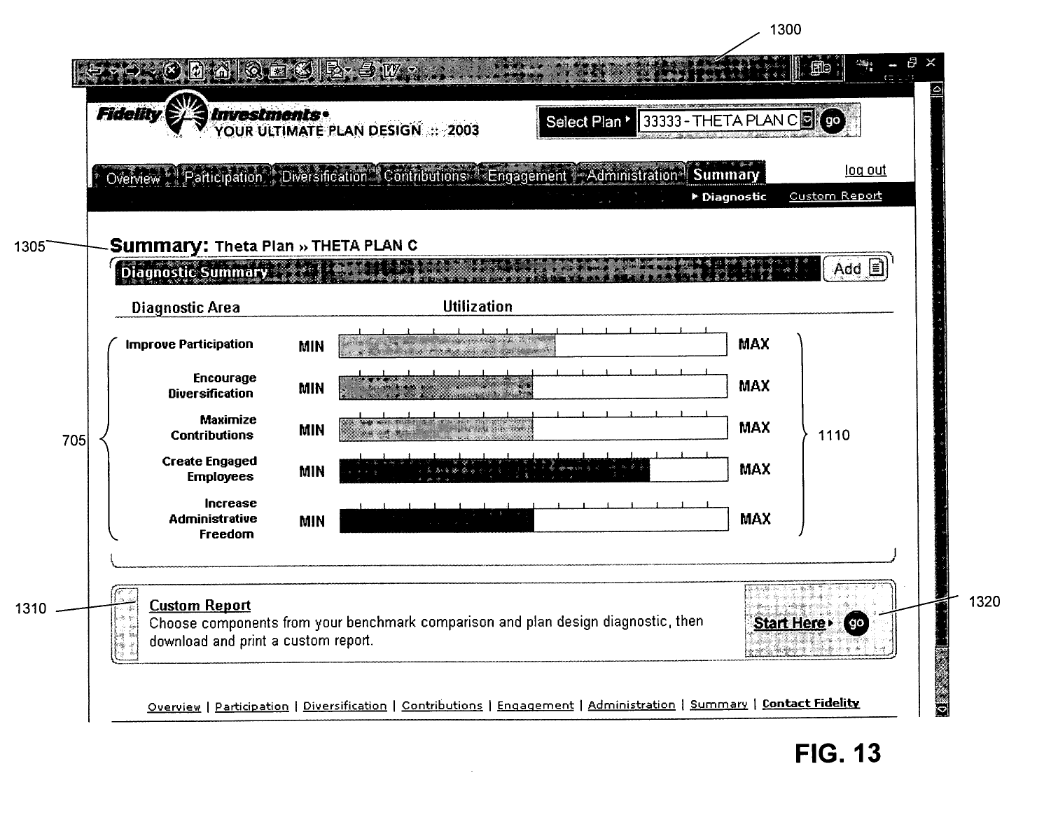

Referring to FIG. 13, in one embodiment, the application server 310 provides the user with a summary screen 1300 summarizing the results of one or more completed diagnostic pages 1000. In one embodiment, the summary screen 1300 includes diagnostic summary 1305 which lists the plan metrics 705 for which the user completed the diagnostics page 1000, and a graphical representation 1110 of the results of the completed questionnaires. In addition, the summary screen includes a custom report section 1310 with instructions on producing a report and a button 1320 to request a custom report screen 1400 from the server 204.

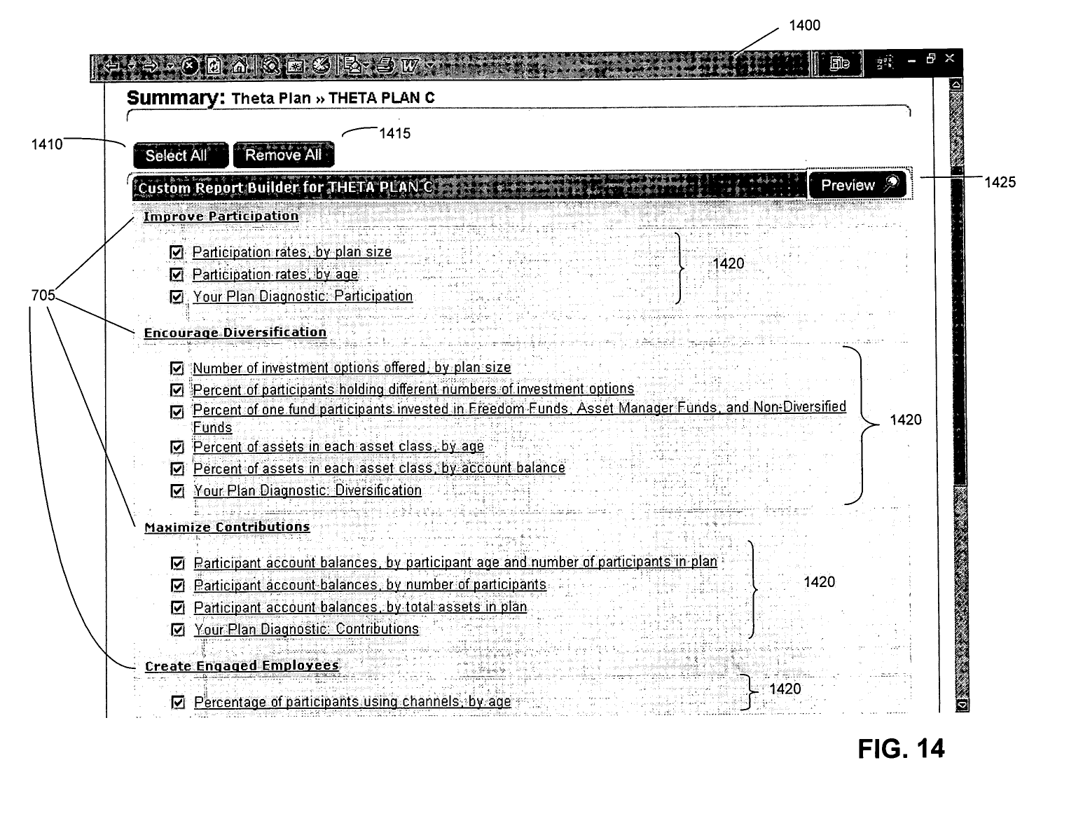

Referring to FIG. 14, the application server 310 provides the user with the custom report builder screen 1400, which allows the user to include on the report along with their calculated metrics 1110, overall metrics and segmented benchmark metrics as described above. The custom report builder screen 1400 includes buttons allowing a user to select 1410 or deselect 1415 all the benchmark data, a preview button 1425, a listing of each plan goal 705 and check boxes for each of the metrics that may be added to the report 1420. Thus, a user may select the specific metrics report relevant to their goals. For example, if a plan record keeper 110 was trying to convince a plan sponsor that they could encourage diversification among the investment vehicles chosen by the plan participants, a representative from the record keeper 110 could choose to include the “Percent of Assets in Each Asset Class, by Age” metric. If the current plan metrics are significantly below those of the other plans within the same sub-segment, the plan sponsor 100 may be encouraged to increase the investment options available in their plan. Furthermore, the data may be even more compelling to the sponsor if the metrics to which his plan is being compared include only those plans having plan sponsors of a similar size and in a similar industry.

Variations, modifications, and other implementations of what is described herein will occur to those of ordinary skill in the art without departing from the spirit and the scope of the invention as claimed. Accordingly, the invention is to be defined not by the preceding illustrative description but instead by the spirit and scope of the following claims.

1. A computerized method of assessing the features an employee benefit plan, comprising:
providing attributes of a first employee benefit plan, the plan having a plan sponsor and a plan record keeper;
providing attributes of other employee benefit plans, each plan having a plan sponsor and a plan record keeper;
determining a subset of the other employee benefit plans; and,
comparing statuses of the attributes of the first employee benefit plan to statuses of the attributes of the subset of the other employee benefit plans.

2. The method of claim 1 wherein the first employee benefit plan is one of a defined contribution plan, a pension plan, and employee stock purchase plan, a deferred compensation plan, and a healthcare plan.

3. The method of claim 2 wherein at least one of the other benefit plans is of the same type of employee benefit plans as the first employee benefit plan.

4. The method of claim 2 wherein the defined contribution plan is one of a 401(k) plan and a 403(b) plan.

5. The method of claim 2 wherein the deferred compensation plan is a 457 plan.

6. The method of claim 1 further including the record keeper of the plan providing the attributes of the first employee benefit plan to the sponsor of the plan.

7. The method of claim 1 further including the record keeper of the first plan providing the attributes of the other benefit plans to the sponsor of the first plan.

8. The method of claim 1 further including the sponsor of the first plan providing the attributes of the first employee benefit plan to the record keeper of the first plan.

9. The method of claim 1 wherein the record keeper performs record keeping functions for at least two of other employee benefit plans are performed by the same entity.

10. The method of claim 1 wherein the record keeping functions for the other employee benefit plans are performed by at least two different entities.

11. The method of claim 1 further comprising using the characteristics of the plan sponsors to determine a subset of the other employee benefit plans.

12. The method of claim 11 wherein the characteristics used to determine the subset includes one or more of: the number of employees, industry, non-profit status, and geographic region.

13. The method of claim 1 wherein the first employee benefit plan is in the subset of employee benefit plans.

14. The method of claim 1 further comprising performing the comparison step for one or more of the following plan metrics: plan participation, plan diversification, participant contribution levels, participant account balances, and participant interaction.

15. The method of claim 14 further comprising performing the comparison step for one or more sub-metrics of the one or more metrics.

16. The method of claim 15 wherein the sub-metrics are one or more of the following: the age of plan participants, the diversification of plan options, and customer service channels used by plan participants.

17. The method of claim 16 further comprising performing the comparison step for one or more sub-sub-metrics of the one or more sub-metrics.

18. A computerized method for providing an action plan to improve an employee benefit plan, comprising:
uniquely associating an improvement action for one or more attributes of an employee benefit plan;
receiving the status of one or more of the one or more attributes of a first employee benefit plan;
identifying the attributes of the first employee benefit plan which have a different status than a set of other employee benefit plans; and
providing an action plan to improve the first employee benefit plan, the action plan comprising one or more of the actions associated with the identified attributes.

19. The method of claim 18 wherein the first employee benefit plan is one of a defined contribution plan, a pension plan, an employee stock purchase plan, a deferred compensation plan, and a healthcare plan.

20. The method of claim 19 wherein the defined contribution plan is one of a 401(k) plan and a 403(b) plan.

21. The method of claim 19 wherein the deferred compensation plan is a 457 plan.

22. The method of claim 18 further comprising selecting the employee benefit plans to be included in the set of other employee benefit plans based at least in part on characteristics of the sponsors of the other employee benefit plan.

23. The method of claim 18 further comprising requesting the status through the use of an online questionnaire.

24. The method of claim 18 further comprising requesting the status from the record keeper of the first employee benefit plan.

25. The method of claim 18 further comprising requesting the status from the sponsor of the first employee benefit plan.

26. The method of claim 18 further comprising associating the attributes of the first employee benefit plan with one or more metrics of the first employee benefit plan.

27. The method of claim 26 wherein the one or more metrics are one or more of: plan participation, plan diversification, participant contribution levels, participant account balances, and customer interaction.

28. The method of claim 27 further comprising performing the comparison step for one or more of the metrics.

29. The method of claim 18 wherein the action plan is displayed on one or more of a printed report and a web page.

30. A computer-based employee benefit plan assessment system, comprising:
means for storing attributes of a plurality of employee benefit plans;
means for segmenting the employee benefit plans into groups based on characteristics of the plan sponsors;
means for deriving a benchmark metric for each group of plans;
means for transmitting attributes of an employee benefit plan to a user;
means for receiving an indication of a status of the attributes of the employee benefit plan from the user; and
means for comparing the received status with the benchmark metric.
